(19) United States
(12) Patent Application Publication
(10) Pub. No.: US 2025/0111223 A1
(43) Pub. Date: Apr. 3, 2025

(54) User Consent Based Model Provisioning

(71) Applicant: Telefonaktiebolaget LM Ericsson (publ), Stockholm (SE)

(72) Inventors: Zhang Fu, Stockholm (SE); Ulf Mattsson, Kungsbacka (SE); Maria Belen Pancorbo Marcos, Madrid (ES)

(21) Appl. No.: 18/725,354

(22) PCT Filed: Dec. 29, 2022
(86) PCT No.: PCT/EP2022/088009

§ 371 Date: Jun. 28, 2024

Related U.S. Application Data
(60) Provisional application No. 63/295,718, filed on Dec. 31, 2021.

(51) Int. Cl. G06N 3/08; H04L 41/14; H04L 41/16; H04W 24/02

(52) U.S. Cl. CPC G06N 3/08; H04L 41/14; H04L 41/16; H04W 24/02

(57) ABSTRACT

When the consumer NWDAF requests a trained machine learning model from a producer NWDAF for a set of Analytic IDs associated with a plurality of UEs, the consumer NWDAF may include a reliability requirement in the model provisioning request to indicate a required accuracy for the machine learning model. The reliability requirement may be expressed in terms of a number of UEs, a percentage of UEs. or an accuracy target. The producer NWDAF determines whether it can provide a trained model satisfying the reliability requirement and responds accordingly. If a trained model meeting the reliability requirement is available, the producer NWDAF provides the location the trained model to the consumer NWDAF.

### TECHNICAL FIELD

The present disclosure relates generally to network data analytics and, more particularly, to model provisioning for a network data analytics function.

### BACKGROUND

Release 15 (Rel-15) of the Third Generation Partnership Project (3GPP) standard for Fifth Generation (5G) networks introduced a new network function called the Network Data Analytics Function (NWDAF) and its basic functionality is specified in Release 16 (Rel-16). Development of more advanced uses cases is ongoing for Release 17 (Rel-17). Generally, the NWDAF performs two types of analytics processing: statistical analytics and predictive analytics. Statistical analytics provide information about what is currently happening in the network (or has happened in the past). Predictive analytics provides information about what is likely to happen in the future, based on current and historical trends.

In the 3GPP standard TS 23.288 v17.2, machine learning model provisioning is defined to enable one NWDAF 90 with a MTLF, referred to herein as the producer NWDAF 90, to provide a trained machine learning model to another NWDAF 90 with an AnLF, referred to herein as the consumer NWDAF 90. The consumer NWDAF 90 is configured with a set of NWDAF identifiers (NWDAF IDs) associated with one or more producer NWDAFs 90 and the Analytics IDs supported by each producer NWDAF 90. The consumer NWDAF 90 may also use NWDAF discovery to within the set of configured NWDAF ID(s) if necessary to find a NWDAF for a particular set of Analytics ID. When the producer NWDAF is identified, the consumer NWDAF 90 can send a request a trained machine learning model for a set of Analytics IDs from the producer NWDAF 90. Two types of requests are available for requesting a machine learning model from a producer NWDAF: a model subscription and a model request. Both are referred to herein more generally as a model provisioning request.

An Analytics Logical Function (AnLF) is a component of a NWDAF that performs data analytics and exposes the analytics service to other NFs. A Model Training Logical Function (MTLF) is a component that trains machine learning models for use in providing the analytics service and exposes the training service to other NFs. A NWDAF can include an AnLF, a MTLF, or both. A NWDAF with a MTLF can train the machine learning model used in providing an analytics service by another NWDAF with an ANLF.

The NWDAF can produce statistics and predictions related to the activity of a user equipment (UE) or group of UEs. These statistics and predictions include, but are not limited to, UE mobility patterns (for example, determining if a UE is stationary or mobile, a prediction of the areas that the UE will visit, etc.) and UE communication patterns (time of communications, duration, maximum uplink and downlink bitrates, etc.). Core network nodes in the 5G core network (5GC), referred to herein as Consumer Network Functions (CNFs), can query the NWDAF or subscribe to receive notifications from the NWDAF to obtain statistics or predictions for a UE or group of UEs. Exemplary CNFs include the Access and Mobility Management Function (AMF) and the Session Management Function (SMF).

Collection of private user data may be subject to local policies or regulations in order to protect the privacy of user data. Thus, the network may be required to obtain user consent to use private user data for model training and/or data analytics. User consent for use of their private data is part of the subscription information stored in the Unified Data management (UDM) node. The subscription data includes information indicating whether the user authorizes the collection and usage of its data for a particular purpose, and the purpose for data collection, e.g., analytics or model training, that is consented to by the user.

Before collecting user data for model training and/or data analytics, the NWDAF needs to check whether user consent is required for the data collection. The NWDAF defines a set of analytics types differentiated by Analytics Identifiers (Analytic IDs). User consent may be required for certain Analytic IDs that collect per user data, or for those where the target for analytics or model training is set to a specific UE or group identifier. Users that have not provided consent are excluded from the data collection.

### SUMMARY

It is an object of the invention to set forth a method of a model provisioning implemented by a consumer network node and a method of model provisioning implemented by a producer network node, both providing for an enhanced model reliability. It is a still further object of the invention to set forth a consumer network node providing an enhanced model reliability and a producer network node providing an enhanced model reliability.

An aspect of the present comprises methods of model provisioning implemented by a consumer network node in a wireless communication network. In one embodiment, the method comprises sending, to a producer network node, a model provisioning request for a machine-learning model associated with a set of analytic identifiers. The model request includes a target identifier associated with a plurality of target UEs whose data is to be used in the model training and a reliability requirement indicative of a required accuracy of the machine learning model. The method further comprises receiving, responsive to the request, a model provisioning response from the from the producer network node.

A still further aspect of the disclosure comprises a consumer network node in a wireless communication network. I one embodiment, the consumer network node is configured to send, to a producer network node, a model provisioning request for a machine-learning model associated with a set of analytic identifiers. The model request includes a target identifier associated with a plurality of target UEs whose data is to be used in the model training and a reliability requirement indicative of a required accuracy of the machine learning model. The consumer network node is further configured to receive, responsive to the request, a model provisioning response from the from the producer network node.

A further aspect of the disclosure comprises a method of model provisioning implemented by a consumer network node in a wireless communication network. The method comprising: sending, to a producer network node, a model provisioning request for a machine-learning model associated with a set of analytic identifiers, the model request including a target identifier associated with a plurality of target user equipment (UEs) whose data is to be used in the model training; and receiving, from the producer network node responsive to the request, a model provisioning response including model information for at least one selected machine learning model, the model information comprises reliability information indicative of reliability of the selected machine learning model.

A further aspect of the disclosure comprises a method of model provisioning implemented by a producer network node in a wireless communication network. The method comprising receiving, from a consumer network node, a model provisioning request for a machine-learning model associated with a set of analytic identifiers, the model request including a target identifier associated with a plurality of target user equipment (UEs) whose data is to be used in the model training; and sending, to the consumer network node responsive to the request, a model provisioning response including model information for at least one selected machine learning model, the model information comprises reliability information indicative of reliability of the selected machine learning According to further aspects, the consumer network node does not include a reliability requirement in the model provisioning request.

Yet another aspect of the disclosure comprises a consumer network node including communication circuitry for communicating with a producer network node in a wireless communication network, and processing circuitry. The processing circuitry is configured to send, to a producer network node, a model provisioning request for a machine-learning model associated with a set of analytic identifiers. The model request includes a target identifier associated with a plurality of target UEs whose data is to be used in the model training and a reliability requirement indicative of a required accuracy of the machine learning model. The processing circuitry is further configured to receive, responsive to the request, a model provisioning response from the from the producer network node.

A further aspect of the disclosure comprises a computer program comprising executable instructions that, when executed by a processing circuit in a consumer network node, causes the consumer network node to perform the method according to the first aspect.

A further aspect of the disclosure comprises a carrier containing a computer program according to the fourth aspect wherein the carrier is one of an electronic signal, optical signal, radio signal, or computer readable storage medium.

A further aspect of the present disclosure relates to methods of model provisioning implemented by a producer network node in a wireless communication network configured to provide a trained machine learning model to a consumer network node. In one embodiment, the method comprises receiving, from a consumer network node, a model provisioning request for a machine-learning model associated with a set of analytic identifiers. The model request includes a target identifier associated with a plurality of target UEs whose data is to be used in the model training and a reliability requirement indicative of a required accuracy of the machine learning model. the method further comprises sending, responsive to the request, a model provisioning response to the consumer network node.

A still further aspect of the disclosure relates to producer network node in a wireless communication network configured to provide a trained machine learning model to a consumer network node. The producer network node is configured to receive, from a consumer network node, a model provisioning request for a machine-learning model associated with a set of analytic identifiers. The model request includes a target identifier associated with a plurality of target UEs whose data is to be used in the model training and a reliability requirement indicative of a required accuracy of the machine learning model. The producer network node is further configured to send, responsive to the request, a model provisioning response to the consumer network node.

A further aspect of the disclosure relates to producer network node in a wireless communication network including communication circuitry for communicating with a consumer network node in the wireless communication network, and processing circuitry. The processing circuitry is configured to receive, from a consumer network node, a model provisioning request for a machine-learning model associated with a set of analytic identifiers. The model request includes a target identifier associated with a plurality of target UEs whose data is to be used in the model training and a reliability requirement indicative of a required accuracy of the machine learning model. The processing circuitry is further configured to send, responsive to the request, a model provisioning response to the consumer network node.

A further aspect of the disclosure comprises a computer program comprising executable instructions that, when executed by a processing circuit in a producer network node, causes the producer network node to perform the method according to the sixth aspect.

A further aspect of the disclosure comprises a carrier containing a computer program according to the ninth aspect wherein the carrier is one of an electronic signal, optical signal, radio signal, or computer readable storage medium.

When a consumer NWDAF with an AnLF requests a trained machine learning model from a producer NWDAF with a MTLF, the consumer NWDAF has no way to determine the accuracy of the trained model provided by the producer NWDAF under the current provisioning scheme known in the art. According to one aspect of the present disclosure, when the consumer NWDAF requests a trained machine learning model from a producer NWDAF for a set of Analytic IDs associated with a plurality of UEs, the consumer NWDAF may include a reliability requirement in the model provisioning request to indicate a required accuracy for the machine learning model. The reliability requirement may be expressed in terms of a number of UEs, a percentage of UEs, or an accuracy target. The producer NWDAF determines whether it can provide a trained model satisfying the reliability requirement and responds accordingly. If a trained model meeting the reliability requirement is available, the producer NWDAF provides the location the trained model to the consumer NWDAF. In some cases, the producer NWDAF may need to train a machine learning model before providing the location. If training is required, the producer NWDAF may subscribe with the UDM to obtain user consent necessary for the model training. If the producer NWDAF is unable to provide a machine learning model that satisfies the reliability requirement, the producer NWDAF can reject the request and provide a reason for rejection (e.g., user consent not given), or provide an alternative model that does not meet the reliability requirement. When providing a location for a trained model, the producer NWDAF may also provide an indication of the reliability of the trained model.

Hence, in use cases where the NWDAF needs to check whether user consent is required for the data collection and where users that have not provided consent are excluded from the data collection, the accuracy of the resulting model and/or analytics is dependent on the number or percentage of users that have provided consent. When the number or percentage of consenting users for model training is low, the resulting model may not accurately represent the group for which the model or data analytics is requested. This disadvantage may be reduced or prevented according to embodiments of the invention.

### BRIEF DESCRIPTION OF THE DRAWINGS

FIG. 1 illustrates a wireless communication network according to an exemplary embodiment.

FIG. 2 illustrates an exemplary producer for model provisioning according to one embodiment.

FIG. 3 illustrates an exemplary procedure for model provisioning according to another embodiment.

FIG. 4 illustrates an exemplary method implemented by a consumer network node for obtaining a trained machine learning model.

FIG. 5 illustrates an exemplary method implemented by a producer network node for providing a trained machine learning model.

FIG. 6 illustrates an exemplary method implemented by a consumer network node for obtaining a trained machine learning model.

FIG. 7 illustrates an exemplary method implemented by a producer network node for providing a trained machine learning model.

FIG. 8 illustrates an exemplary consumer network node configured to obtain a trained machine learning model.

FIG. 9 illustrates an exemplary producer network node configured to provide a trained machine learning model.

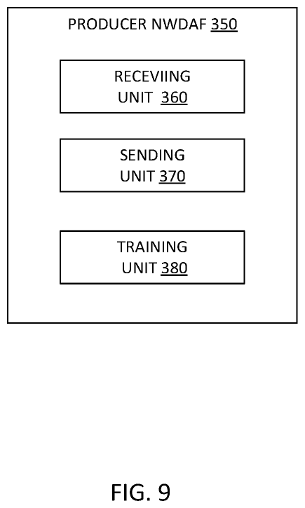

FIG. 10 illustrates an exemplary network node that can be configured as a consumer network node, a producer network node, or both.

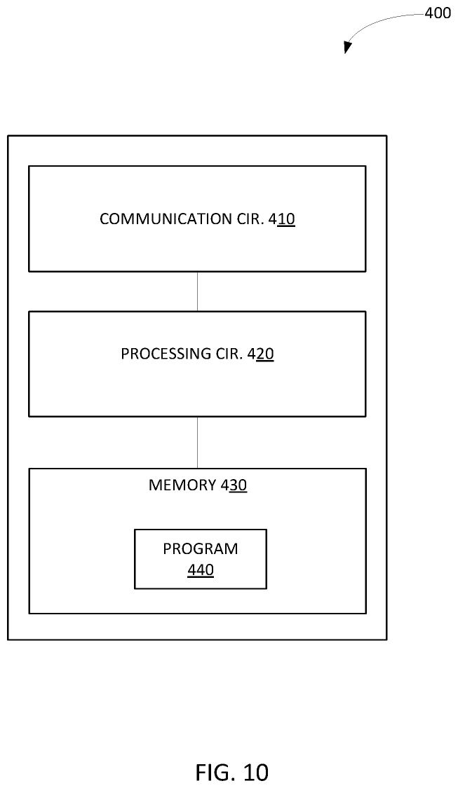

### DETAILED DESCRIPTION

Referring now to the drawings, an exemplary embodiment of the disclosure will be described in the context of a 5G wireless communication network. Those skilled in the art will appreciate that the methods and apparatus herein described are not limited to use in 5G networks but may also be used in wireless communication networks operating according to other standards.

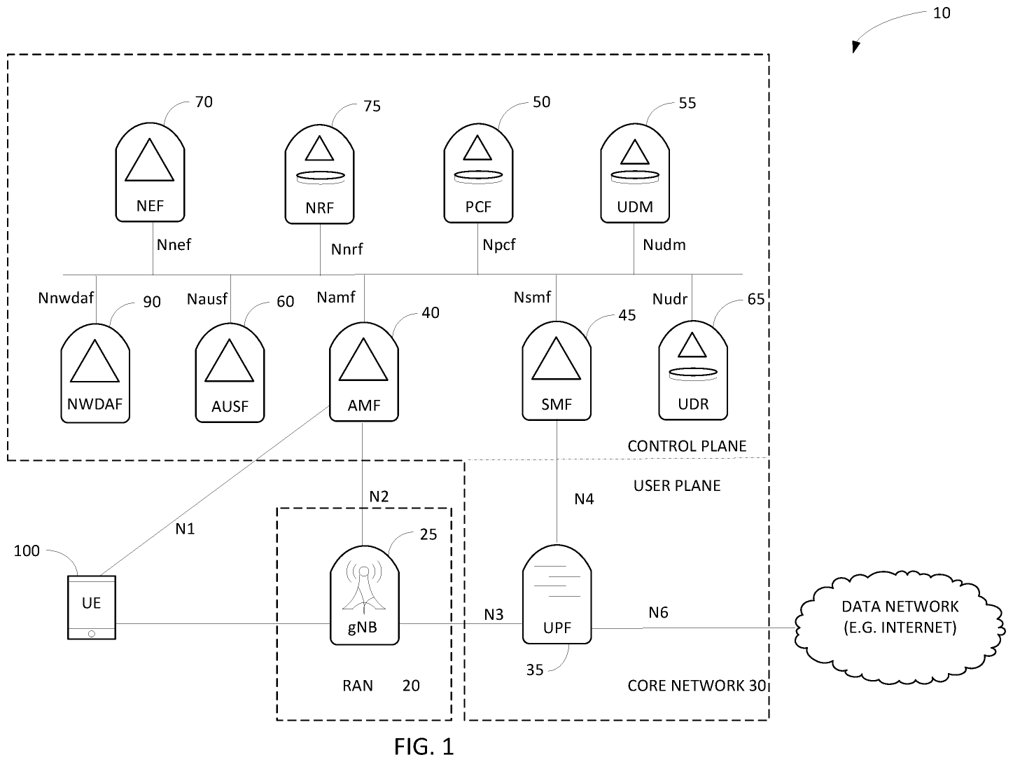

FIG. 1 illustrates a wireless communication network 10 according to one exemplary embodiment. The wireless communication network 10 comprises a radio access network (RAN) 20 and a core network 30 employing a service-based architecture. The RAN 20 comprises one or more base stations 25 providing radio access to UEs 100 operating within the wireless communication network 10. The base stations 25 are also referred to as gNodeBs (gNBs). The core network 30 provides a connection between the RAN 20 and other packet data networks, such as the Internet Protocol (IP) Multimedia Subsystem (IMS) or the Internet.

In one exemplary embodiment, the core network 30 comprises a plurality of network functions (NFs), include a User Plane Function (UPF) 35, an Access and Mobility Management Function (AMF) 40, a Session Management Function (SMF) 45, a Policy Control Function (PCF) 50, a Unified Data Management (UDM) function 55, an Authentication Server function (AUSF) 60, a Unified Data Repository (UDR) 65, a Network Exposure Function (NEF) 70 and a Network Repository Function (NRF) 75. The core network 30 additionally includes a NWDAF 90 for generating and distributing analytics reports. These NFs comprise logical entities that reside in one or more core network nodes, which may be implemented by one or more processors, hardware, firmware, or a combination thereof. The functions may reside in a single core network node or may be distributed among two or more core network nodes.

In conventional wireless communication network, the various NFs (e.g., SMF 45, AMF 40, etc.) in the core network 30 communicate with one another over predefined interfaces. In the service-based architecture shown in FIG. 1, instead of predefined interfaces between the control plane functions, the wireless communication network 10 uses a services model in which the NFs query the NRF 75 or other NF discovery node to discover and communicate with each other.

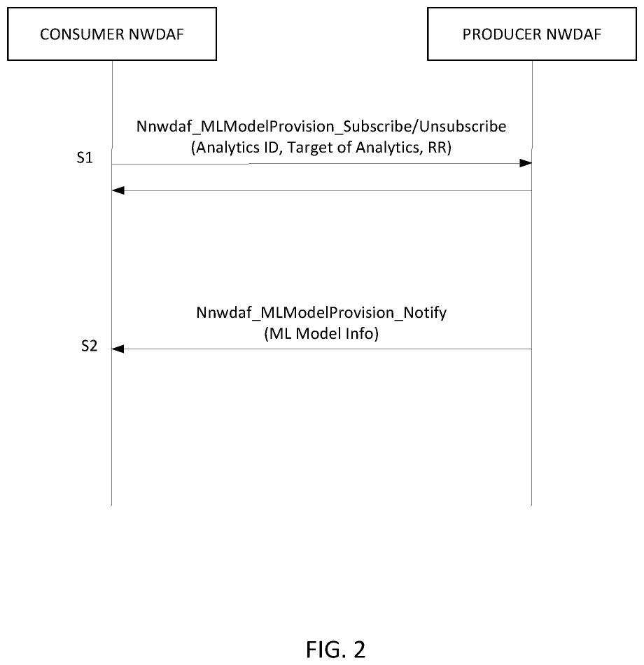

FIG. 2 illustrates a procedure used by a consumer NWDAF 90 to create, modify or cancel a subscription with a producer NWDAF 90 for ML model information for certain specified Analytics IDs. When the subscription is created, the consumer NWDAF 90 will be notified when ML model information for the specified Analytics IDs becomes available. The ML model information can then be used by the consumer NWDAF 90 to generate analytics. This procedure uses the Nnwdaf_MLModelProvision services as defined in 3GPP TS 23.288 v17.2 (hereinafter TS 23.288), clause 7.5.

The consumer NWDAF 90 sends a subscription request (e.g., Nnwdaf_MLModelProvision_Subscribe/Unsubscribe message) to create, modify or cancel a subscription with the producer NWDAF 90 for a set of trained ML models associated with a set of Analytics IDs (S1). The request includes a list of Analytics IDs that identifies the analytics for which the ML model is used and a Notification Target Address used for correlating notifications received from the producer NWDAF 90 with the subscription. The subscription request may further include ML Model Filter Information, the Target of Analytics Reporting and the ML Model Target Period. The ML Model Filter Information enables the producer NWDAF 90 to select a particular ML model for the analytics is requested, e.g. S-NSSAI, Area of Interest. The Target of Analytics Reporting indicates the entities for which the ML model for the analytics is requested. The target entities may be a list of specific UEs, a group of UE(s) identified by an internal or external group identifier (Group ID), or any UE (i.e., all UEs). The ML Model Target Period indicates the start and end time (e.g., via UTC time) of a time interval for which the ML model for the analytics is requested.

When a consumer NWDAF 90 with an AnLF requests a trained machine learning model from a producer NWDAF 90 with a MTLF, the consumer NWDAF 90 has no way to determine the accuracy of the trained model provided by the producer NWDAF 90 under the current provisioning scheme. According to one aspect of the present disclosure, when the consumer NWDAF 90 requests a trained machine learning model from a producer NWDAF 90 for a set of Analytic IDs with a plurality of UEs as the target, the consumer NWDAF 90 may include a reliability requirement (RR) in the subscription request or other model provisioning request to indicate a required accuracy for the machine learning model. The reliability requirement may be expressed in terms of a number of UEs, a percentage of UEs, or an accuracy target.

When a subscription for a trained ML model associated with an Analytics ID is received, the producer NWDAF 90 determines whether an existing trained ML Model satisfying the reliability requirement is available and/or determine whether additional training for an existing trained ML models is needed to meet the reliability requirement. If the producer NWDAF 90 determines that additional training is needed, the producer NWDAF 90 may initiate data collection from other NFs (e.g. AMF, SMF, etc.), UE application (via an Application Function (AF)) or Operations & Management System (OAM) to generate the ML model. If the producer NWDAF 90 is able to provide a ML model that meets the reliability requirement, the producer NWDAF 90 answers the subscription request to confirm the subscription. If the producer NWDAF 90 is not able to provide a ML model that meets the reliability requirement, the producer NWDAF 90 may reject the request. If the request is rejected, the answer to the subscription request may include a cause for the rejection. The cause may indicate, for example, that the producer NWDAF 90 is unable to provide a model due to lack of user consent for a sufficient number of users to meet the reliability requirement.

If the subscription is confirmed, the producer NWDAF 90 notifies the consumer NWDAF 90 with the trained ML model information when available by sending a Nnwdaf_MLModelProvision_Notify message (S2). The ML model information contains the file address for each trained ML model for the Analytics IDs that meet the reliability requirement specified in the subscription. The file address may, for example, comprise a Uniform Resource Locator (URL) or Fully Qualified domain Name (FQDN). The notification message may further include a validity period indicating a time period when the provided ML model information applies, and a spatial validity indicating an area where the ML model information applies.

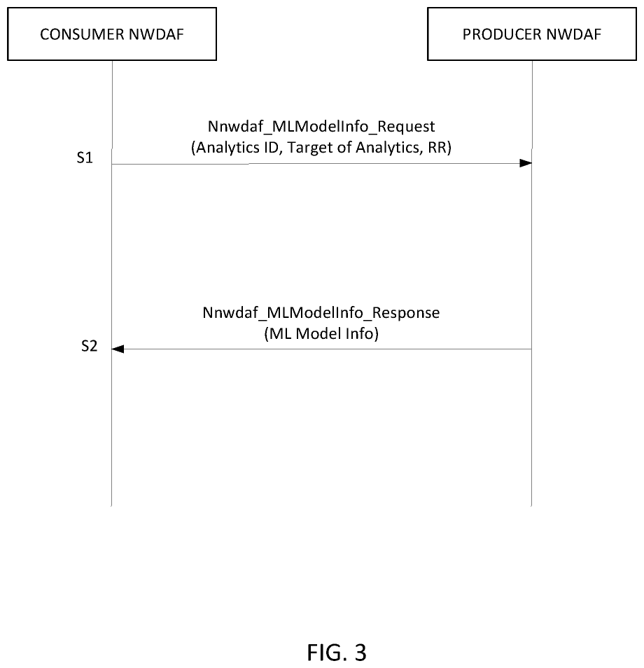

FIG. 3 illustrates a procedure to request ML model information. This procedure uses the Nnwdaf_MLModelInfo services as defined in TS 23.288, clause 7.6. This procedure is invoked when the consumer NWDAF 90 sends a model information request (e.g., Nnwdaf_MLModelInfo_Request message) to the producer NWDAF (S1). The model information request may include the same information as used in the subscription request and is not repeated here except to note that the request may identify a plurality of target IDs for the specified Analytics IDs and include a reliability requirement.

When a model information request for a trained ML model associated with an Analytics ID is received, the producer NWDAF 90 determines whether an existing trained ML Model satisfies the reliability requirements and/or whether additional training for an existing trained ML model is needed to meet the reliability requirement. If the producer NWDAF 90 determines that additional training is needed, the producer NWDAF 90 may initiate data collection as previously described. If the producer NWDAF 90 is able to provide a ML model that meets the reliability requirement, the producer NWDAF 90 answers the model information request and provides the model information in the response (S2). The model information in the response to the model information request may be the same as the model information in the notification message as previously described.

As previously noted, collection of private user data may be subject to local policies or regulations in order to protect the privacy of user data. Thus, the producer NWDAF 90 may be required to obtain user consent to use private user data for model training and/or data analytics. User consent for use of their private data is part of the subscription information stored in the Unified Data management (UDM) node. The subscription data includes information indicating whether the user authorizes the collection and usage of its data for a particular purpose, and the purpose for data collection, e.g., analytics or model training, that is consented to by the user. Before collecting user data for model training and/or data analytics, the producer NWDAF 90 needs to check whether user consent is required for the data collection. User consent may be required for certain Analytic IDs that collect per user data, or for those where the target for analytics or model training is set to a specific UE or group identifier. Users that have not provided consent are excluded from the data collection.

If user consent is needed for model training, the producer NWDAF 90 retrieves the user consent to data collection and usage for a user from the UDM as described in TS 23.288, clause 6.2.2 and clause 6.2.6. If user consent for a user is granted, then the NWDAF 90 subscribes to user consent updates with the UDM 55 using the Nudm_SDM_Subscribe service operation. Otherwise, the NWDAF 90 the corresponding SUPI from the data collection. Thus, the producer NWDAF 90 can provide analytics or ML model to consumers that request analytics or ML model for an Internal or External Group Id, or for “any UE”, by skipping those users for which consent is not granted or is revoked.

If a request for analytics is for “any UE”, meaning that the consumer NWDAF 90 requests analytics for all UEs registered in an area, such as a Single Network Slice Selection Assistance Information (S-NSSAI) or Data Network Name (DNN), the producer NWDAF 90 resolves “any UE” into a list of Subscription Permanent Identifiers (SUPIs) and retrieves user consent for each SUPI. Similarly, if a request for analytics is for an Internal or External Group ID, the producer NWDAF 90 resolves it into a list of SUPIs and retrieves user consent for each SUPI.

If the UDM 55 notifies the producer NWDAF 90 that the user consent has changed for one or more UEs, the producer NWDAF 90 checks if the user consent for the purpose of analytics or model training has been revoked. If user consent for model training is revoked for a UE, the NWDAF 90 stops data collection for that UE and excludes that UE from future model training. If the Target for Analytics or Target of ML Model Reporting is either an Internal or External Group Id or a list of SUPIs or “any UE”, the NWDAF 90 skips those SUPIs that do not grant user consent for the purpose of analytics or model training. The NWDAF 90 may unsubscribe to be notified of user consent updates from UDM for users for which data consent has been revoked. The exclusion of UEs from model training can impact the reliability of the trained models. In embodiments of the present invention, a new parameter referred to as the reliability requirement is defined and included in a model provisioning request when the consumer NWDAF 90 requests a trained model for a plurality of UEs. The reliability requirement can be expressed as a representative rate (percentage of the related UEs whose data is used in the model training), a number of UEs whose data is used in the model training, or a target accuracy. The reliability requirement enables the consumer NWDAF 90 to request a ML model with a desired accuracy. The reliability requirement is useful in cases where the analytics is performed for a group of UEs, which is identified in the Target of Analytics Reporting parameter, the group can be identified by a list of SUPIs, a list of a list of internal or external Group IDs, or some combination thereof. The Target of Analytics Reporting may also indicate “any UE”, which means all UEs in an area of interest (e.g., all UEs served by the S-NSSAI, etc.). The reliability requirement enables the consumer NWDAF 90 to set a requirement for the model accuracy. For example, the consumer NWDAF 90 may specified that the ML model is trained using a specified number of UEs or a specified percentage of the target UEs. A third alternative is that the consumer NWDAF 90 could express any requirements such as accuracy of the model in the request. The producer NWDAF 90 receiving the model provisioning request checks if it has a trained model which can satisfy the reliability requirement or if it can train a model that meets the reliability requirement. If so, producer NWDAF 90 may provide the trained model to the consumer and, if not, the producer NWDAF 90 may reject the request. In some embodiments, a rejection cause is included in the response to the provisioning request indicating, for example, that there are not enough UEs to generate a ML model. The rejection cause may further provide a reason, i.e., user consent was not granted for X % of the SUPIs.

In some embodiments, the producer NWDAF 90 may provide an alternative ML model that does not meet the reliability requirement. In this case, the producer NWDAF 90 includes an indication of the accuracy in the model information, e.g., model trained based on X % of target UEs. The model information may further include a reason for the lower accuracy, e.g., user consent not granted. The model provisioning request (e.g. subscription request of model information request) may include an indication whether alternative models are permitted.

In some embodiments, the producer NWDAF 90 may decide to train a new model for the target UEs. In this case, the producer NWDAF 90 collects user consent for the target UEs as previously described. If the number of target UEs providing consent is not sufficient to train the model to the required level of accuracy, the producer NWDAF 90 can reject the model provisioning request with the rejection cause, e.g. insufficient number of UEs providing consent. In some embodiments, the consumer NWDAF 90 may also include a flag in the model provisioning request. The flag indicates that if there are not enough UEs for model training, the NWDAF 90 should notify the consumer when there are enough UEs so that the consumer NWDAF 90 can request the model at that time. In this case, the NWDAF 90 may subscribe to UDM for the user consent updates and, when enough UEs have given consent to train the model, the producer NWDAF 90 will notify the consumer NWDAF. The producer NWDAF 90 can train the model and provide the model together with the notification.

In some embodiments, the producer NWDAF 90 may include a reliability indicator in the model information provided to the consumer NWDAF 90 if the model is for a group of UE or “any UE” in an Area of Interest. The reliability indicator may indicate a percentage of the target UEs whose data is used in the model training, the number of target UEs whose data is used in the model training, or an accuracy of the model. According to embodiments, the consumer network node does not include a reliability requirement in the model provisioning request. The producer NWDAF 90 may provide the reliability indicator even if the consumer NWDAF 90 does not include a reliability requirement in the model provisioning request.

In some embodiments, the producer NWDAF 90 subscribes to receive user consent updates with UDM 55 for the group of UEs or the UEs in the area of interest. When more UEs grant user consent, the producer NWDAF 90 may decide to retrain the ML model and provide the updated model to the consumer NWDAF 90. If some UEs revoke consent, the producer NWDAF 90 may inform the consumer NWDAF 90 to stop using the model with the reason, e.g. UEs revoked user consent.

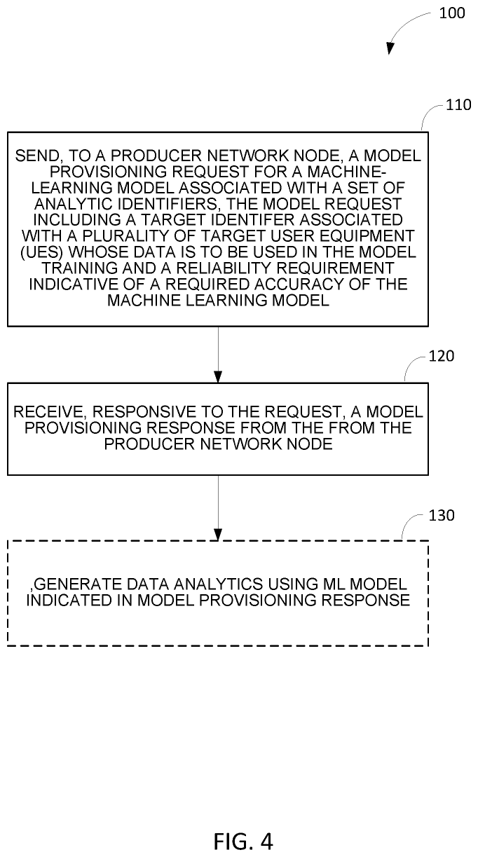

FIG. 4 illustrates an exemplary method 100 of model provisioning implemented by a consumer network node in a wireless communication network. The consumer NWDAF 90 sends, to a producer NWDAF, a model provisioning request for a machine-learning model associated with a set of analytic identifiers (block 110). The model request includes a target identifier associated with a plurality of target UEs whose data is to be used in the model training and a reliability requirement indicative of a required accuracy of the machine learning model. Responsive to the request, the consumer NWDAF 90 receives a model provisioning response from the from the producer NWDAF 90 (block 120). In some embodiments, the consumer NWDAF 90 receives model information from the producer NWDAF for a machine learning model and uses the machine learning model to generate data analytics for a consumer NF (block 130).

In some embodiments of the method 100, the reliability requirement is expressed as at least one of a number of the target UEs to be used in model training, a percentage of the target UEs to be used in model training, or an accuracy target for the trained model.

In some embodiments of the method 100, the target identifier comprises at least one of a list of UE identifiers for specific UEs, a group identifier for a group of two or more UEs, or an “any UE” indication.

In some embodiments of the method 100, the model provisioning request further includes filter information for use in model selection.

In some embodiments of the method 100, the model provisioning request further includes a target period for which the model is requested.

In some embodiments of the method 100, the model provisioning response includes location information for a machine learning model selected responsive to the request.

In some embodiments of the method 100, the location information is for a trained machine learning model that meets the required accuracy as indicated by the reliability indicator. In some embodiments of the method 100, the location information is for an alternative machine learning model that does not meet the required accuracy as indicated by the reliability indicator. In some embodiments of the method 100, the model provisioning request includes an indication that the alternative machine learning model is allowed.

In some embodiments of the method 100, the model provisioning response further includes an indication that non-compliance is due to lack of user consent for a sufficient number of UEs among the plurality of UEs to train the machine learning model.

In some embodiments of the method 100, the model provisioning response further includes a reliability indicator indicating a reliability of the machine learning model indicated in the model provisioning response.

In some embodiments of the method 100, the model provisioning response further includes at least one of a time parameter indicating a time period when a provided machine learning model is valid, or a spatial parameter indicating an area where a provided machine learning model applies.

Some embodiments of the method 100 further comprise retrieving the machine learning model using the location information, obtaining user data, and applying the machine learning model to the user data to determine an action.

Some embodiments of the method 100 further comprise receiving, from the producer network node, a model provisioning response including an indication that the requested model is not available due to lack of user consent for a sufficient number of UEs in the plurality of UEs to train the machine learning model.

In some embodiments of the method 100, the model request comprises a model subscription request.

In some embodiments of the method 100, the model provisioning response comprises a notification message responsive to the model subscription request.

In some embodiments of the method 100, the model request comprises a model information request.

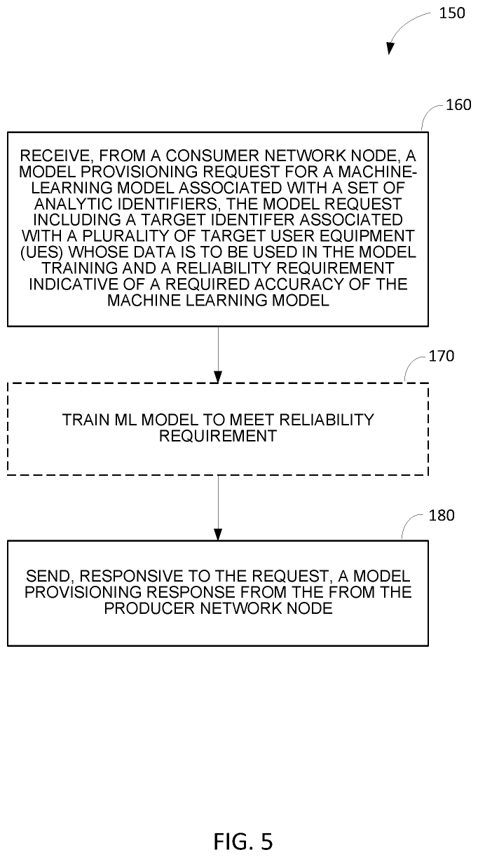

FIG. 5 illustrates a method 150 of model provisioning implemented by a producer NWDAF 90 in a wireless communication network configured to provide a trained machine learning model to a consumer network node. The producer NWDAF 90 receives, from a consumer NWDAF, a model provisioning request for a machine-learning model associated with a set of analytic identifiers (block 160). The model request includes a target identifier associated with a plurality of target UEs whose data is to be used in the model training and a reliability requirement indicative of a required accuracy of the machine learning model. In some embodiments, the producer NWDAF 90 optionally trains a machine learning model to meet the reliability requirement (block 170). The producer NWDAF 90 sends, responsive to the request, a model provisioning response to the consumer NWDAF 90 (block 180).

In some embodiments of the method 150, the reliability requirement is expressed as at least one of a number of the target UEs to be used in model training, a percentage of the target UEs to be used in model training, or an accuracy requirement for the trained model.

In some embodiments of the method 150, the target identifier comprises at least one of a list of UE identifiers for specific UEs, a group identifier for a group of two or more UEs, or an “any UE” indication.

In some embodiments of the method 150, the model provisioning request further includes filter information for use in model selection.

In some embodiments of the method 150, the model provisioning request further includes a target period for which the model is requested.

Some embodiments of the method 150 further comprise determining whether a trained machine learning model compliant with the reliability requirement is available.

In some embodiments of the method 150, when a trained machine learning model compliant with the reliability requirement is available, including in the model provisioning response location information for the trained machine learning model.

In some embodiments of the method 150, when a trained machine learning model compliant with the reliability requirement is not available, including in the model provisioning response location information for an alternative machine learning model.

In some embodiments of the method 150, the model provisioning request further includes an indication that the alternative machine learning model is allowed

Some embodiments of the method 150 further comprise, including in the model provisioning response an indication that non-compliance is due to lack of user consent for a sufficient number of UEs in the plurality of UEs to train the machine learning model.

Some embodiments of the method 150 further comprise including in the model provisioning response a reliability indicator for the machine learning model indicated in the model provisioning response.

Some embodiments of the method 150 further comprise, when a trained machine learning model compliant with the reliability requirement is not available but a sufficient number of UEs to train the machine learning model have provided consent, training the machine learning model and including in the model provisioning response location information for the trained machine learning model.

Some embodiments of the method 150 further comprise determining whether a sufficient number of UEs is available to train the machine learning model based on UE subscription information.

Some embodiments of the method 150 further comprise collecting user consent from one or more of the target UEs.

Some embodiments of the method 150 further comprise subscribing to receive notifications related to user consent for the target UEs.

In some embodiments of the method 150, the model provisioning response further includes at least one of a time parameter indicating a time period when a provided machine learning model is valid, or a spatial parameter indicating an area where a provided machine learning model applies.

Some embodiments of the method 150 further comprise retrieving the machine learning model using the location information, obtaining user data, and applying the machine learning model to the user data to determine an action.

Some embodiments of the method 150 further comprise, when a trained machine learning model compliant with the reliability requirement is not available due to lack of consent for a sufficient number of target UEs, rejecting the model provisioning request and including an indication in the model provisioning response that the rejection is due to lack of consent for a sufficient number of target UEs to meet the accuracy requirement.

In some embodiments of the method 150, the model request comprises a model subscription request.

In some embodiments of the method 150, the model provisioning response comprises a notification message responsive to the model subscription request.

In some embodiments of the method 150, the model provisioning request comprises a model information request.

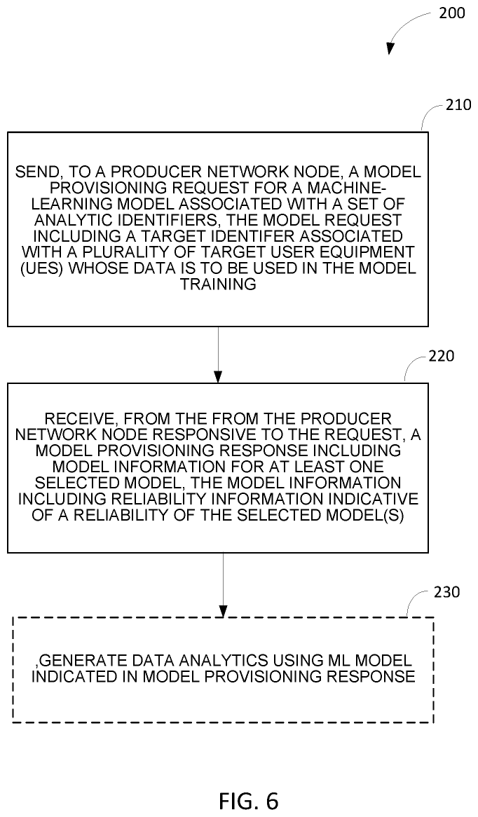

FIG. 6 illustrates an exemplary method 200 of model provisioning implemented by a consumer network node in a wireless communication network. The consumer NWDAF 90 sends, to a producer NWDAF, a model provisioning request for a machine-learning model associated with a set of analytic identifiers (block 210). The model request includes a target identifier associated with a plurality of target UEs whose data is to be used in the model training. Responsive to the request, the consumer NWDAF 90 receives from the from the producer NWDAF 90 a model provisioning response including model information (block 220). The model information comprises reliability information indicative of a reliability of the selected machine learning model. In some embodiments, the consumer NWDAF 90 receives model information from the producer NWDAF for a machine learning model and uses the machine learning model to generate data analytics for a consumer NF (block 230).

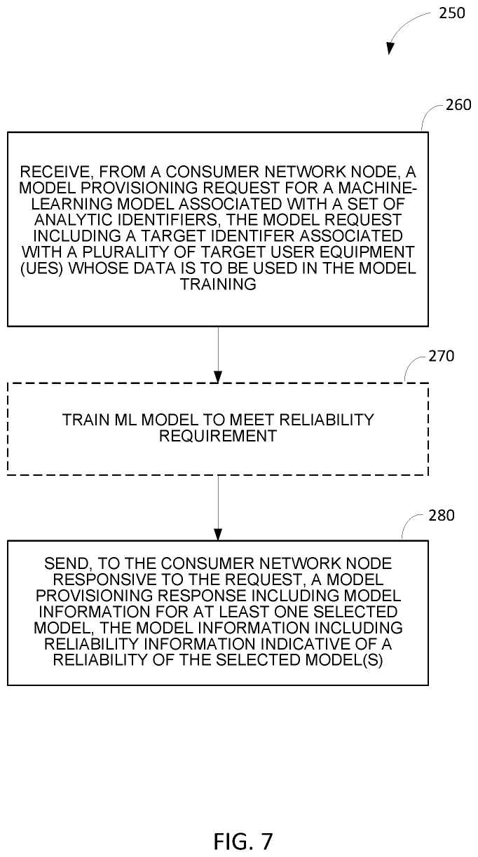

FIG. 7 illustrates a method 250 of model provisioning implemented by a producer NWDAF 90 in a wireless communication network configured to provide a trained machine learning model to a consumer network node. The producer NWDAF 90 receives, from a consumer NWDAF, a model provisioning request for a machine-learning model associated with a set of analytic identifiers (block 260). The model request includes a target identifier associated with a plurality of target UEs whose data is to be used in the model training. In some embodiments, the producer NWDAF 90 optionally trains a machine learning model to meet the reliability requirement (block 270). The producer NWDAF 90 sends, to the consumer NWDAF 90 responsive to the request, a model provisioning response including model information for at least one selected machine learning model (block 280). The model information comprises reliability information indicative of reliability of the selected machine learning model

The methods herein described can be implemented by an apparatus comprising any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

FIG. 6 illustrates a consumer NWDAF in a wireless communication network. The consumer NWDAF generally comprises a sending unit 310, a receiving unit 320 and an optional analytics unit 330. The various units 310-330 may be implemented by hardware and/or by software code that is executed by one or more processors or processing circuits. In a first embodiment, the sending unit 310 is configured to send, to a producer NWDAF 90, a model provisioning request for a machine-learning model associated with a set of analytic identifiers. The model request includes a target identifier associated with a plurality of target UEs whose data is to be used in the model training and a reliability requirement indicative of a required accuracy of the machine learning model. The receiving unit 320 is configured to receive, responsive to the model provisioning request, a model provisioning response from the from the producer NWDAF. In a second embodiment, the sending unit 310 is configured to sending, to a producer NWDAF 90, a model provisioning request for a machine-learning model associated with a set of analytic identifiers, the model request including a target identifier associated with a plurality of target user equipment (UEs) whose data is to be used in the model training. The receiving unit 320 is configured to receive from the producer NWDAF 90, a model provisioning response including model information for at least one selected machine learning model. The model information comprises reliability information indicative of reliability of the selected machine learning model. In the first and second embodiments, the analytics unit 330 is configured to use a trained machine learning model provided by the producer NWDAF 90 to generate analytics for a consumer NF.

FIG. 7 illustrates a producer NWDAF 350 in a wireless communication network configured to provide a trained machine learning model to a consumer network node. The producer NWDAF 350 comprises a receiving unit 360, a sending unit 370, and an optional model training unit 380. The various units 360-380 may be implemented by hardware and/or by software code that is executed by one or more processors or processing circuits. In a first embodiment, the receiving unit 360 is configured to receive, from a consumer NWDAF, a model provisioning request for a machine-learning model associated with a set of analytic identifiers. The model request includes a target identifier associated with a plurality of target user equipment (UEs) whose data is to be used in the model training and a reliability requirement indicative of a required accuracy of the machine learning model. The sending unit 370 is configured to send, responsive to the request, a model provisioning response to the consumer NWDAF 90. In a second embodiment, the receiving unit 360 is configured to receive, from a consumer NWDAF, a model provisioning request for a machine-learning model associated with a set of analytic identifiers. The model request includes a target identifier associated with a plurality of target user equipment (UEs) whose data is to be used in the model training. The sending unit 370 is configured to send to the consumer NWDAF 90, responsive to the request, a model provisioning response including model information for at least one selected machine learning model. The model information comprises reliability information indicative of reliability of the selected machine learning model(s). The model training unit 380, when present, is configured to train a machine learning model for a consumer NF.

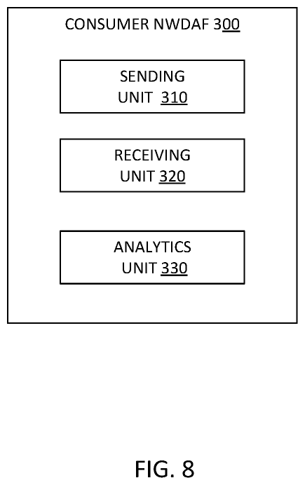

FIG. 8 illustrates a core network node 400 according to one embodiment that may be configured to function as a consumer NWDAF or producer NWDAF as herein described. The core network node 400 comprises interface circuitry 420, processing circuitry 420, and memory 430. Interface circuitry 420 couples the core network node 400 to a communication network and enables communication with other core network nodes in the wireless communication network. Processing circuitry 420 controls the overall operation of the core network node 400 and executes computer programs 440 stored in memory 430 to perform one or more of the methods as herein described. Processing circuitry 420 may comprise one or more microprocessors, hardware, firmware, or a combination thereof. The processing circuitry is configured to perform one or more of the methods 100, 150, 200, 250 shown in FIGS. 4-7.

Memory 430 comprises both volatile and non-volatile memory for storing computer program code and data needed by the processing circuit 420 for operation. Memory 430 may comprise any tangible, non-transitory computer-readable storage medium for storing data including electronic, magnetic, optical, electromagnetic, or semiconductor data storage. Memory 430 stores a computer program 440 comprising executable instructions that configure the processing circuitry 420 to implement the methods as described herein. A computer program 440 in this regard may comprise one or more code modules corresponding to the means or units described above. In general, computer program instructions and configuration information are stored in a non-volatile memory, such as a ROM, erasable programmable read only memory (EPROM) or flash memory. Temporary data generated during operation may be stored in a volatile memory, such as a random-access memory (RAM). In some embodiments, computer program core network node 400 for configuring the processing circuit 420 as herein described may be stored in a removable memory, such as a portable compact disc, portable digital video disc, or other removable media. The computer program 430 may also be embodied in a carrier such as an electronic signal, optical signal, radio signal, or computer readable storage medium.

Those skilled in the art will also appreciate that embodiments herein further include corresponding computer programs. A computer program comprises instructions that, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

1-67. (canceled)

68. A method of model provisioning implemented by a consumer network node in a wireless communication network, the method comprising:
sending, to a producer network node, a model provisioning request for a machine-learning model associated with a set of analytic identifiers, the model request including a target identifier associated with a plurality of target user equipment (UEs) whose data is to be used in the model training and a reliability requirement indicative of a required accuracy of the machine learning model; and
receiving, responsive to the request, a model provisioning response from the from the producer network node.

69. The method of claim 68, wherein the reliability requirement is expressed as at least one of:
a number of the target UEs to be used in model training;
a percentage of the target UEs to be used in model training; or
an accuracy target for the trained model.

70. The method of claim 68, wherein the target identifier comprises at least one of:
a list of UE identifiers for specific UEs;
a group identifier for a group of two or more UEs; or
an “any UE” indication.

71. The method of claim 68 wherein the model provisioning request further includes filter information for use in model selection.

72. The method of claim 68, wherein model provisioning request further includes a target period for which the model is requested.

73. The method of claim 68, wherein the model provisioning response includes location information for a machine learning model selected responsive to the request.

74. The method of claim 73, wherein the location information is for a trained machine learning model that meets the required accuracy as indicated by the reliability indicator.

75. The method of claim 73, wherein the location information is for an alternative machine learning model that does not meet the required accuracy as indicated by the reliability indicator.

76. The method of claim 75, wherein the model provisioning request includes an indication that the alternative machine learning model is allowed.

77. The method of claim 75, wherein the model provisioning response further includes an indication that non-compliance is due to lack of user consent for a sufficient number of UEs among the plurality of UEs to train the machine learning model.

78. The method of claim 73, wherein the model provisioning response further includes a reliability indicator indicating a reliability of the machine learning model indicated in the model provisioning response.

79. The method of claim 73, wherein the model provisioning response further includes at least one of:
a time parameter indicating a time period when a provided machine learning model is valid; or
a spatial parameter indicating an area where a provided machine learning model applies.

80. The method of claim 73, further comprising:
retrieving the machine learning model using the location information;
obtaining user data; and
applying the machine learning model to the user data to determine an action.

81. The method of claim 68, further comprising receiving, from the producer network node, a model provisioning response including an indication that the requested model is not available due to lack of user consent for a sufficient number of UEs in the plurality of UEs to train the machine learning model.

82. The method of claim 68 wherein the model request comprises a model subscription request.

83. The method of claim 82, wherein the model provisioning response comprises a notification message responsive to the model subscription request.

84. The method of claim 68, wherein the model request comprises a model information request.

85. The method of claim 68, wherein the model provisioning response comprises model information for at least one selected model, the model information including location information for the selected model to enable retrieval of the model by the consumer network node.

86. The method of claim 85 wherein the model information further includes reliability information indicative of a reliability of the selected model.

87. The method of claim 86 wherein the reliability information comprises at least one of:
a number of the target UEs used in model training;
a percentage of the target UEs used in model training; or
an accuracy for the trained model.

88. A method of model provisioning implemented by a consumer network node in a wireless communication network, the method comprising:
sending, to a producer network node, a model provisioning request for a machine-learning model associated with a set of analytic identifiers, the model request including a target identifier associated with a plurality of target user equipment (UEs) whose data is to be used in the model training; and
receiving, from the producer network node responsive to the request, a model provisioning response including model information for at least one selected machine learning model, the model information comprises reliability information indicative of reliability of the selected machine learning model.

89. A method of model provisioning implemented by a producer network node in a wireless communication network, the method comprising:
receiving, from a consumer network node, a model provisioning request for a machine-learning model associated with a set of analytic identifiers, the model request including a target identifier associated with a plurality of target user equipment (UEs) whose data is to be used in the model training; and
sending, to the consumer network node responsive to the request, a model provisioning response including model information for at least one selected machine learning model, the model information comprises reliability information indicative of reliability of the selected machine learning model.

90. A consumer network node in a wireless communication network, the consumer network node comprising:
communication circuitry for communicating with a producer network node in a wireless communication network; and
processing circuitry configured to:
send, to a producer network node, a model provisioning request for a machine-learning model associated with a set of analytic identifiers, the model request including a target identifier associated with a plurality of target user equipment (UEs) whose data is to be used in the model training; and
receive, from the producer network node responsive to the request, a model provisioning response including model information for at least one selected machine learning model, the model information comprises reliability information indicative of reliability of the selected machine learning model.

91. A producer network node in a wireless communication network, the consumer network node being configured to:
receive, from a consumer network node, a model provisioning request for a machine-learning model associated with a set of analytic identifiers, the model request including a target identifier associated with a plurality of target user equipment (UEs) whose data is to be used in the model training; and
send, to the consumer network node responsive to the request, a model provisioning response including model information for at least one selected machine learning model, the model information comprises reliability information indicative of reliability of the selected machine learning model.
